(19) United States
(12) Patent Application Publication
(10) Pub. No.: US 2017/0165865 A9
(43) Pub. Date: Jun. 15, 2017

(54) EXOTHERMIC POWDERS FOR ADDITIVE MANUFACTURING

(71) Applicant: Applied Materials, Inc., Santa Clara, CA (US)

(72) Inventors: Ajey M. Joshi, San Jose, CA (US); Ashavani Kumar, Sunnyvale, CA (US); Kasiraman Krishnan, Milpitas, CA (US); Nag B. Patibandla, Pleasanton, CA (US)

(73) Assignee: Applied Materials, Inc., Santa Clara, CA (US)

(21) Appl. No.: 15/216,166

(22) Filed: Jul. 21, 2016

Related U.S. Application Data
(60) Provisional application No. 62/195,232, filed on Jul. 21, 2015.
(60) Provisional application No. 62/165,118, filed on May 21, 2015.

(51) Int. Cl. B28B 1/00; B33Y 70/00; B33Y 10/00; C04B 35/78; C04B 35/65

(52) U.S. Cl. CPC B28B 1/001; C04B 35/78; C04B 35/651; B33Y 10/00; B33Y 70/00; C04B 2235/404; C04B 2235/405; C04B 2235/407; C04B 2235/3217; C04B 2235/3418; C04B 2235/65

(57) ABSTRACT

A method of additive manufacturing to form a component comprises successively depositing a plurality of layers to form the component. Depositing at least one of the plurality of layers includes depositing a layer of a first particulate precursor over a platen, depositing a second particulate precursor on portions of the platen over the layer of the first particulate precursor specified by a controller, and directing energy to the second particulate precursor deposited on the portion of the platen to cause an exothermic chemical reaction between the first particulate precursor and the second particulate precursor. The exothermic chemical reaction produces heat that sinters products of the chemical reaction to fabricate the layer of the component.

### CROSS-REFERENCE TO RELATED APPLICATIONS

This application claims priority to U.S. Provisional Application Ser. No. 62/195,232, filed on Jul. 21, 2015, and to U.S. Provisional Application Ser. No. 62/165,118, filed on May 21, 2015, the entire disclosures of which are incorporated by reference.

### TECHNICAL FIELD

The present invention relates generally to additive manufacturing, also known as 3D printing.

### BACKGROUND

Additive manufacturing (AM), also known as solid freeform fabrication or 3D printing, refers to any manufacturing process where three-dimensional objects are built up from raw material (generally powders, liquids, suspensions, or molten solids) in a series of two-dimensional layers or cross-sections. In contrast, traditional machining techniques involve subtractive processes and produce objects that are cut out of a stock material such as a block of wood, plastic or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g., stereolithography (SLA).

Sintering is a process of fusing small grains, e.g., powders, to create objects. Sintering usually involves heating a powder. When a powdered material is heated to a sufficient temperature in a sintering process, the atoms in the powder particles diffuse across the boundaries of the particles, fusing the particles together to form a solid piece. In contrast to melting, the powder used in sintering need not reach a liquid phase. As the sintering temperature does not have to reach the melting point of the material, sintering is often used for materials with high melting points such as tungsten and molybdenum.

Both sintering and melting can be used in additive manufacturing. Selective laser melting (SLM) is used for additive manufacturing of metals or metal alloys (e.g. titanium, gold, steel, Inconel, cobalt chrome, etc.), which have a discrete melting temperature and undergo melting during the SLM process.

Typical 3D printing process for such materials can involve fabrication of a green part by first printing onto a layer of CMC powder, and then sintering the polymer or metal coated ceramic particles or mixture of polymer/metal and ceramic particles using SLS. The process is completed by de-bonding the binder, densifying the green part, and high temperature sintering.

### SUMMARY

In one aspect a method of additive manufacturing to form a component comprises successively depositing a plurality of layers to form the component. Depositing at least one of the plurality of layers includes depositing a layer of a first particulate precursor over a platen, depositing a second particulate precursor on portions of the platen over the layer of the first particulate precursor specified by a controller, and directing energy to the second particulate precursor deposited on the portion of the platen to cause an exothermic chemical reaction between the first particulate precursor and the second particulate precursor. The exothermic chemical reaction produces heat that sinters products of the chemical reaction to fabricate the layer of the component.

Implementations may include one or more of the following features. The heat that sinters the products of the chemical reaction may cause consolidation of the component.

The first particulate precursor may include a powder of particulates of an oxide of a second metal and the second particulate precursor may include a powder of particulates of a first material. Directing energy to the particular precursor may include melting the particulates of the first material. Melting the particulates of the first material may trigger an exothermic reaction that forms the products of the chemical reaction. The products may include an oxide of the first material and the second metal, and heat from the exothermic reaction may sinter the oxide of the first material with the second metal. The first material may include be aluminum, a semiconductor, e.g., silicon, or carbon. The oxide of the second metal may be one or more of MoO3, Fe2O3, NiO, and CuO. The component may be ceramic matrix composite.

Depositing the layer of the first particulate precursor may include depositing a continuous layer across the platen or an underlying layer. Applying energy may include selectively applying energy to portions of the first particulate precursor. Selectively applying energy may include scanning a laser beam across the layer of the first particulate precursor.

Depositing the layer of the first particulate precursor may include selectively depositing the particulate precursor over portions of the platen. Applying energy may include applying energy to all of the layer of the first particulate precursor simultaneously. Applying energy to all of the layer of the first particulate precursor simultaneously may include heating the layer of particulate precursor with an array of heat lamps.

In another aspect, a method of additive manufacturing to form a component includes successively depositing a plurality of layers to form the component. Depositing at least one of the plurality of layers includes depositing a particulate precursor on portions of a platen specified by a controller, and directing energy to the particulate precursor deposited on the portion of the platen to cause an exothermic chemical reaction of the particulate precursor. The exothermic chemical reaction produces heat that sinters products of the chemical reaction to fabricate the layer of the component.

Implementations may include one or more of the following features. The heat that sinters the products of the chemical reaction may cause consolidation of the component.

The particulate precursor may include a powder of particulates of a first material and a powder of particulates of an oxide of a second metal. The particulates of the first material and the particulates of the oxide may be mixed before being dispensed over the platen. Directing energy to the particular precursor may include melting the particulates of the first material. Melting the particulates of the first material may trigger an exothermic reaction that forms the products of the chemical reaction. The products may include an oxide of the first material and the second metal, and heat from the exothermic reaction may sinter the oxide of the first material with the second metal. The first material may be aluminum, a semiconductor, e.g., silicon, or carbon. The oxide of the second metal comprises one or more of MoO3, Fe2O3, NiO, and CuO. The component comprises ceramic matrix composite.

In another aspect, a precursor for forming a additively manufactured component includes a powder of particulates of a first material and a powder of particulates of a second material. The second material is an oxide of a metal, and the particulates of the first material have a chemical composition such that melting triggers an exothermic reaction between the particulates of the first material and the particulates of the second material that forms an oxide of the first material and reduces the oxide of the second metal to the second metal, and heat from the exothermic reaction sinters the oxide of the first material with the second metal, and sintering the oxide of the first material with the second metal produces a portion of the additively manufactured component.

Implementations may include one or more of the following features. The first material may be a first metal, e.g., aluminum. The particulates of the first material may have a mean diameter between 5 nm to 150 microns. The particulates of the second material may have a mean diameter between 5 nm to 150 microns. The first material may include a semiconductor, e.g., silicon, or include carbon. The oxide of the second metal may include one or more of MoO3, Fe2O3, NiO, or CuO.

In another aspect, an additively manufactured component may be a ceramic matrix composite formed using the precursor above. The component may be a component used in one or more of aerospace engineering, automobile, and infrastructure industries.

In another aspect, an additively manufactured component may be ceramic matrix composite formed using the precursor above, and the ceramic matric composite may include one or more of silicon carbide, alumina, and mullite.

The disclosed materials and systems can allow 3D printing of CMC materials at lower temperatures with higher throughput, and can also allow CMC materials which have not previously been printed to be used. In other words, a larger number of sintered parts can be formed (i.e., a higher throughput can be achieved) when a constant amount of energy is provided per unit time. A lower amount of energy can be used to form a sintered part containing CMC material. Lower processing temperatures can also mean a low thermal budget and a lower cost of ownership. The techniques and methods disclosed herein can allow other compound material which have not been printed so far be used in additive manufacturing.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an exemplary additive manufacturing system.

FIG. 2 shows another exemplary additive manufacturing system.

Like reference symbols in the various drawings indicate like elements.

### DETAILED DESCRIPTION

Ceramic matrix composites (CMC) do not fracture easily under mechanical or thermo-mechanical loads because of cracks initiated by small defects or scratches, that can occur with the conventional technical ceramics like alumina, silicon carbide, aluminum nitride, silicon nitride or zirconia. To increase the crack resistance or fracture toughness, particles (so-called monocrystalline whiskers or platelets) can be embedded into the matrix. Carbon (C), special silicon carbide (SiC), alumina (Al₂O₃) and mullite (Al₂O₃—SiO₂) fibers are most commonly used for CMCs. They can be the matrix materials for CMCs. Advantages of CMC can include its extreme thermal shock resistance, its dynamical load capability, and its strongly increased fracture toughness.

CMC are known for light-weight, high strength, stability at high temperature, corrosion or oxidation resistance materials. These materials are considered promising candidates for the future generations of space engines, thermal protection systems, as well as extremely heat loaded industrial applications. More specific applications include structural materials for propulsion, exhaust, armors, automotive disc brakes, jet's landing gear, etc.

Typical 3D printing processes that produce parts made of CMC materials may include first producing a green part by printing a binder onto a layer of CMC powder. The polymer/metal coated ceramic particles or mixture of polymer/metal and ceramic particles can then be sintered using selective laser sintering (SLS). After the binder is de-bonded from the green part, additional materials (e.g., the CMC powder) can be infiltrated into the green part to densify it. The densified green part is then processed by high temperature sintering. The desired density of the finished part may not be achieved even after the various steps in this procedure.

Using a new type of precursor designed for printing ceramic matrix composite materials, parts having the desired density and quality (e.g., surface finish) can be produced in a process that have fewer steps. The new material and processes can result in high throughput and/or higher quality parts in 3D manufacturing.

In some embodiments, the precursor can be a powder of particulates that includes formulations of metals and metal oxides designed to undergo exothermic intermetallic reactions. In particular, the precursor can include a mixture of two kinds of powder: a first particulate precursor, e.g., a first powder, composed of metallic or metalloid particles, and a second particulate precursor, e.g., a second powder, composed of metal oxide particles that will undergo exothermic intermetallic reaction with the metallic or metalloid particles when triggered, e.g., when melted.

Examples of such energetic formulations for aluminum based CMC are shown in Table 1. The release of heat from the exothermic reactions can cause reactive sintering during the 3D printing process.

TABLE 1
Aluminum based CMC

| Al based | |
|---|---|
| CMC | Precursor |
| Al₂O₃-Mo | Al, MoO₃ |
| Al₂O₃-Fe | Al, Fe₂O₃ |
| Al₂O₃-Ni | Al, NiO |
| Al₂O₃-Cu | Al, CuO |

For example, a 3D printed part can include Al₂O₃—Fe, in which metallic iron is embedded in a matrix of alumina (Al₂O₃). To 3D print such a part, a first particulate precursor that can be elemental aluminum particles (e.g., metallic aluminum particles, aluminum powder), is mixed with a second particulate precursor that includes iron oxide particles.

One way of triggering the exothermic intermetallic reaction is by supplying heat to the precursor. For example, the aluminum powder can be heated to its melting temperature of ˜660° C. The melting of the aluminum provides enough activation energy that allows an exothermic redox reaction:

Fe₂O₃+2 Al→2Fe+Al₂O₃

to occur. In this redox reaction, elemental aluminum in its ground oxidation state (oxidation state of 0) is oxidized to Al³⁺, while iron in its 3+ oxidation state is reduced to elemental iron. This exothermic reaction releases −841 J of energy. The energy released from this reaction is then simultaneously being used to sinter the elemental iron with the alumina, to yield a CMC having metallic iron embedded in a matrix of alumina.

Analogous reactions can occur between copper (II) oxide and aluminum, yielding a CMC having elemental copper embedded in alumina, together with the release of 1198 J of energy. Similarly, nickel (II) oxide can react with aluminum to produce a CMC having elemental nickel embedded in a matrix of alumina, together with the release of 947 kJ or energy. The energy released from each of the exothermic redox reactions can be used to sinter the redox products into the desired CMC. In other words, the locations at which the redox products are sintered can be part of the finished 3D printed product. The use of the first and second precursors allows consolidation during printing and can reduce (e.g., eliminate) extensive post-processing of the printed part (e.g., densifying of the green part).

In addition to aluminum based CMC, silicon based CMC can also be formed, using respective precursors as listed in Table 2.

TABLE 2
Silicon based CMC

| Silicon | |
|---|---|
| based | |
| CMC | Precursor |
| SiO₂-Fe | Si, Fe₂O₃ |
| SiO₂-Cu | Si, CuO |
| SiO₂-Ni | Si, NiO |
| SiO₂-Mo | Si-MoO₃ |

To form the silicon based CMC SiO₂—Fe, the first particulate precursor can include elemental silicon particles, and the second particulate precursor can include iron (III) oxide particles. The exothermic redox reaction can be triggered by supplying heat to the silicon, for example to melt it. The melting point of silicon is 1,414° C. The heat evolved when silicon is oxidized into silica (SiO₂) and iron (III) oxide is reduced into elemental iron, can allow the silicon based CMC material to sinter and consolidate into the desired 3D printed part.

In addition to the aluminum or silicon based CMC discussed above, metal carbide based CMC can be produced when a carbon precursor is introduced as one of the precursors. Metal silicates precursors, which can include cement, may also be used.

In general, the use of energetic formulations of precursors can have one or more of the following advantages. The precursors are self-heating and self-sintering. The energy required to form the CMC material from the precursor materials which are self-heating can involve simply providing a smaller amount of energy (e.g., melting of one of the precursors) in order to activate or to trigger an exothermic chemical reaction in which more (e.g., much more) heat is produced compared to the amount of heat initially imparted to the precursor. When the reaction products from the redox reactions are self-sintering, the heat concomitantly produced from the redox reaction can sinter the redox product together, forming the 3D printed part. In this way, 3D printed parts can be fabricated at a high throughput even when a lower (e.g., minimum) amount of energy is delivered.

The chemical conversion of the precursor material can be followed (e.g., immediately) by the self-sintering of the reaction products without any additional application of heat. In this way, sintering effectively takes place during the process in which the CMC material is produced, reducing (e.g., avoiding) extensive post processing steps, and can thus reduce the cost of 3D producing the CMC parts. The ability to 3D print the CMC part via in situ chemical reactions of the precursor materials also allows better control over the composition of the 3D printed structure.

The methods and systems disclosed herein can be used for manufacturing, prototyping, novel material formulations, and additive manufacturing. For example, the disclosed materials, methods and systems can be used to manufacture high value products or components for aerospace engineering, automobile, infrastructure industries, military applications, heavy machinery manufacturing, oil and gas industries etc.

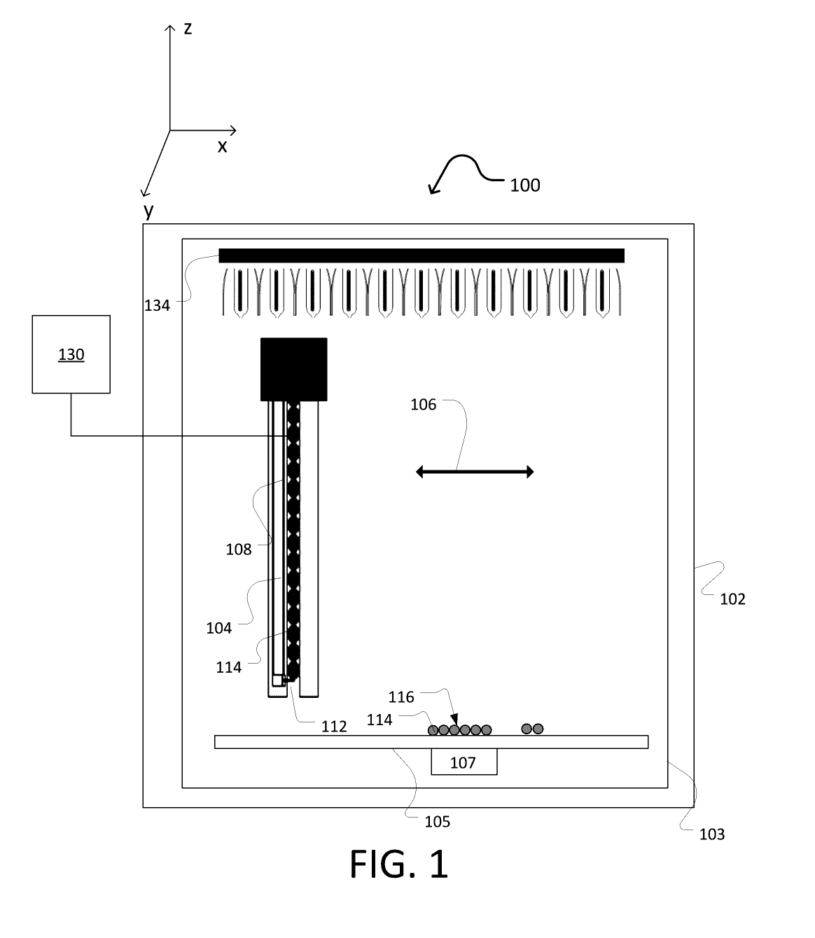

FIG. 1 shows a schematic of an exemplary additive manufacturing system 100. The system 100 includes and is enclosed by a housing 102. The housing 102 can, for example, allow a vacuum environment to be maintained in a chamber 103 inside the housing, but alternatively the interior of the chamber 103 can be a substantially pure gas, e.g., a gas that has been filtered to remove particulates. The vacuum environment or the filtered gas can reduce defects during manufacturing of a part.

The additive manufacturing system 100 includes a material dispenser assembly 104 positioned above a platen 105. The dispenser assembly 104 includes a reservoir 108 to hold a feed material 114. Release of the feed material 114 is controlled by a gate 112. The gate 112 can be provided by a piezoelectric printhead, and/or one or more of pneumatic valves, microelectromechanical systems (MEMS) valves, solenoid valves, or magnetic valves. The feed material 114 is used to refer collectively to the first particulate precursor and the second particulate precursor.

In some implementations, the dispenser assembly 104 can deliver the feed material in a carrier fluid, e.g. a high vapor pressure carrier, e.g., Isopropyl Alcohol (IPA), ethanol, or N-Methyl-2-pyrrolidone (NMP), to form the layers. The carrier fluid can evaporate prior to the sintering step for the layer. Alternatively, a dry dispensing mechanism, e.g., an array of nozzles assisted by ultrasonic agitation and pressurized inert gas, can be employed to dispense the feed material.

The particulates of the first and/or the second particulate precursor can have a mean diameter between 5 nm to 150 μm. The material dispenser assembly 104 can include separate dispensers for the first particulate precursor and the second particulate precursor (not shown in FIG. 1). Alternatively, the dispenser can contain a prepared mixture of the first and second particulate precursors.

A vertical position of the platen 105 can be controlled by a piston 107. A controller 130 controls a drive system (not shown), e.g., a linear actuator, connected to the dispenser assembly 104. The drive system is configured such that, during operation, the dispenser assembly 104 is movable back and forth parallel to the top surface of the platen 105 (along the direction indicated by arrow 106). For example, the dispenser assembly 104 can be supported on a rail that extends across the chamber 103. As the dispenser assembly 104 scans across the platen, the dispenser assembly 104 deposits feed material at an appropriate location on the platen 105 according to a printing pattern that can be stored as a computer aided design (CAD)-compatible file that is then read by a computer associated with the controller 130. Electronic control signals are sent to the gate 112 to dispense the feed material when the dispenser is translated to a position specified by the CAD-compatible file.

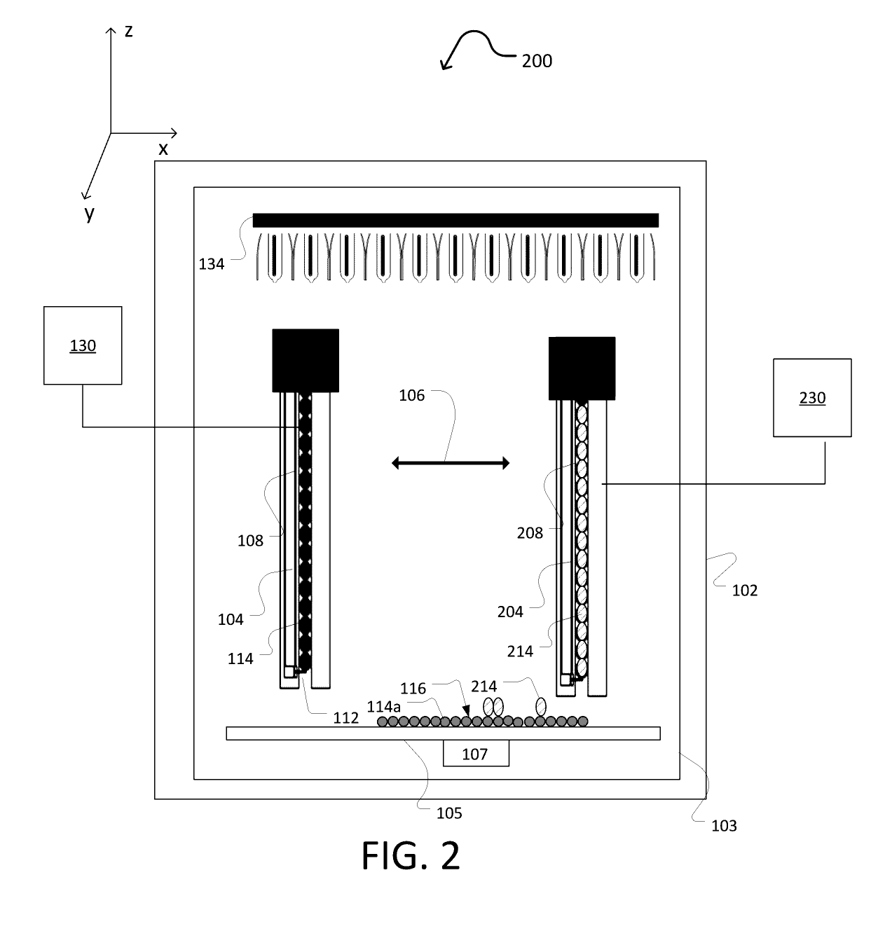

Alternatively, as shown in FIG. 2, in a system 200, the components of the feed material 114 be deposited on the platen in separate steps. For example, the dispenser assembly 104 can dispense only the first particulate precursor 114a. In this case, the first particulate precursor 114a can be deposited uniformly on the platen 105 to form a continuous layer across the platen or an underlying layer.

The dispenser assembly 104 can be as described for FIG. 1, or the dispenser assembly can include a reservoir that includes a support adjacent the platen 105 to hold the first particulate precursor, and a device, such as roller or a blade, to push the feed material off the support and across the platen 105.

The other (i.e., second particulate precursor material 214) is deposited at selected locations on the platen, as specified by the CAD-compatible file. Depositing the layer of the first particulate precursor can include selectively depositing the particulate precursor over portions of the platen. The second particulate precursor material 214 can be dispensed by a separate dispenser assembly 204 having a separate reservoir 208. The dispenser assembly 204 can be constructed as the dispenser assembly 104 described for FIG. 1, but supply second particulate precursor material 214. The assembly 204 can be driven by a controller 230.

Alternatively, the second particulate precursor material could be dispensed in a continuous layer, and the first particulate precursor could be selectively deposited.

Exothermic reactions occur after energy is supplied to a location containing both the first particulate precursor and the second particulate precursor. Thus, as heat is applied across the platen, only the portions of the layer that include both the first powder and the second powder will fuse, leaving regions having just one of the powders, e.g., just the first particulate powder, in a particulate form. This can permit that powder to support later deposited layers of feed material.

For the implementations of both FIG. 1 and FIG. 2, a heat source 134 can be used to melt the particulate precursor.

Alternatively, energy can be applied to all of the layer of the first particulate precursor simultaneously, for example, by using an array of heat lamps.

During manufacturing, layers of feed materials are progressively deposited and sintered or melted. For example, the feed material 114 is dispensed from the dispenser assembly 104 to form a layer 116 that contacts the platen 105.

In some embodiments, the platen 105 can additionally be heated by an embedded heater to a base temperature that is below the melting point of the feed material. In this way, the heat source 134 can be configured to provide a smaller temperature increase to melt the deposited feed material. Transitioning through a small temperature difference can enable the feed material to be processed more quickly. For example, the base temperature of the platen 105 can be about 600° C. when the precursor includes aluminum and the laser beam can cause a temperature increase of about 60° C. Alternatively, the platen can be maintained at about 1400° C. when the precursor includes silicon.

Referring to either FIG. 1 or FIG. 2, the controller 130 or 230 is connected to the various components of the system, e.g., actuators, valves, and heat sources, to generate signals to those components and coordinate the operation and cause the system to carry out the various functional operations or sequence of steps described above. The controller can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

As noted above, the controller can include non-transitory computer readable medium to store a data object, e.g., a computer aided design (CAD)-compatible file, that identifies the pattern in which the feed material should be deposited for each layer. For example, the data object could be a STL-formatted file, a 3D Manufacturing Format (3MF) file, or an Additive Manufacturing File Format (AMF) file. For example, the controller could receive the data object from a remote computer. A processor in the controller, e.g., as controlled by firmware or software, can interpret the data object received from the computer to generate the set of signals necessary to control the components of the system to print the specified pattern for each layer.

A number of embodiments of the invention have been described. Nevertheless, it will be understood that various modifications may be made without departing from the spirit and scope of the invention. Accordingly, other embodiments are within the scope of the following claims.

What is claimed is:

1. A method of additive manufacturing to form a component, the method comprising:
successively depositing a plurality of layers to form the component, wherein depositing at least one of the plurality of layers includes
depositing a layer of a first particulate precursor on a platen;
depositing a second particulate precursor on portions of the platen over the layer of the first particulate precursor specified by a controller; and
directing energy to the second particulate precursor deposited on the portion of the platen to cause an exothermic chemical reaction between the first particulate precursor and the second particulate precursor, wherein the exothermic chemical reaction produces heat that sinters products of the chemical reaction to fabricate the layer of the component.

2. The method of claim 1, wherein the first particulate precursor is a metal oxide, the metal oxide being MoO₃, Fe₂O₃, NiO, or CuO, or a combination thereof.

3. The method of claim 1, wherein the second particulate precursor is aluminum, silicon or carbon, or a combination thereof.

4. A method of additive manufacturing to form a component, the method comprising:
successively depositing a plurality of layers to form the component, wherein depositing at least one of the plurality of layers includes
depositing a particulate precursor on portions of a platen specified by a controller, and
directing energy to the particulate precursor deposited on the portion of the platen to cause an exothermic chemical reaction of the particulate precursor, wherein the exothermic chemical reaction produces heat that sinters products of the chemical reaction to fabricate the layer of the component.

5. The method of claim 4, wherein the heat that sinters the products of the chemical reaction causes consolidation of the component.

6. The method of claim 4, wherein the particulate precursor comprises a powder of particulates of a first material and a powder of particulates of an oxide of a second metal, wherein directing energy to the particular precursor comprises melting the particulates of the first material.

7. The method of claim 6, wherein melting the particulates of the first material triggers an exothermic reaction that forms the products of the chemical reaction, the products comprise an oxide of the first material and the second metal, and heat from the exothermic reaction sinters the oxide of the first material with the second metal.

8. The method of claim 6, wherein the particulates of the first material are a metal oxide, the metal oxide being MoO₃, Fe₂O₃, NiO, or CuO, or a combination thereof.

9. The method of claim 6, wherein the particulates of the oxide of the second metal are aluminum, silicon or carbon, or a combination thereof.

10. The method of claim 4, wherein depositing the layer of the first particulate precursor comprises depositing a continuous layer across the platen or an underlying layer.

11. The method of claim 10, wherein applying energy comprises selectively applying energy to portions of the first particulate precursor.

12. The method of claim 4, wherein depositing the layer of the first particulate precursor comprises selectively depositing the particulate precursor over portions of the platen.

13. The method of claim 12, wherein applying energy comprises applying energy to all of the layer of the first particulate precursor simultaneously.

14. The method of claim 4, wherein the component comprises ceramic matrix composite.

15. A precursor for forming a additively manufactured component, the precursor comprising:
a powder of particulates of a first material; and
a powder of particulates of a second material, the second material being an oxide of a second metal,
wherein the particulates of the first material have a chemical composition such that melting triggers an exothermic reaction between the particulates of the first material and the particulates of the second material that forms an oxide of the first material and reduces the oxide of the second metal to the second metal, wherein heat from the exothermic reaction sinters the oxide of the first material with the second metal, and wherein sintering the oxide of the first material with the second metal produces a portion of the additively manufactured component.

16. The precursor of claim 15, wherein the first material is a metal or is silicon or carbon, or a combination thereof.

17. The precursor of claim 16, wherein the first material includes aluminum.

18. The precursor of claim 15, wherein the oxide of the second metal comprises one or more of MoO₃, Fe₂O₃, NiO, or CuO.

19. The precursor of claim 15, wherein the particulates of the first material have a mean diameter between 5 nm to 150 μm.

20. The precursor of claim 15, wherein the particulates of the second material have a mean diameter between 5 nm to 150 μm.
